(19) United States
(12) Patent Application Publication
(10) Pub. No.: US 2009/0116550 A1
(43) Pub. Date: May 7, 2009

(54) VIDEO COMPRESSION SYSTEM, METHOD AND COMPUTER PROGRAM PRODUCT USING ENTROPY PREDICTION VALUES

(75) Inventor: Gisle Bjontegaard, Oppegard (NO)

Correspondence Address: OBLON, SPIVAK, MCCLELLAND MAIER & NEUSTADT, P.C., 1940 DUKE STREET, ALEXANDRIA, VA, 22314, US

(73) Assignee: TANDBERG TELECOM AS, Lysaker (NO)

(21) Appl. No.: 12/202,568

(22) Filed: Sep. 2, 2008

(30) Foreign Application Priority Data
Sep. 3, 2007 (NO) 20074463

(51) Int. Cl. H04N 7/26

(52) U.S. Cl. 375/240.03; 375/E07.139

(57) ABSTRACT

A method, apparatus and computer program product is configured to perform entropy coding of quantized transform coefficients when for some reason no pixels are available for prediction. Different variable length code tables are used for when pixel value predictions are available, or not. If not available, a fixed value is inserted in a block of pixels which is used as the prediction block for deriving the residual block, which in turn are transformed and quantized. A special variable length code table is then used to represent low frequency coefficients of the quantized transform coefficients.

### CROSS REFERENCE TO RELATED FOREIGN APPLICATION

The present application claims the benefit of the earlier filing date of Norwegian Patent Application No. 20074463, filed in the Norwegian Patent Office on Sep. 3, 2007, the entire contents of which being incorporated herein by reference.

### BACKGROUND OF THE INVENTION

1. Field of the Invention

The present invention is related to the application of entropy coding of transform coefficient data in video compression systems, methods and computer program product.

2. Description of the Related Art

Transmission of moving pictures in real-time is employed in many applications, such as video conferencing, net meetings, TV broadcasting and video telephony.

However, representing moving pictures requires bulk information, such as digital video which is typically described by representing each pixel in a picture or video frame with 8 bits (1 Byte). Such uncompressed video data results in large bit volumes, and can not readily be transferred over conventional communication networks and transmission lines in real-time due to limited bandwidth.

Thus, real time video transmission in practical systems usually employs extensive data compression. Data compression may, however, compromise picture quality. Therefore, great efforts have been made to develop compression techniques allowing real-time transmission of high quality video over bandwidth limited data connections.

In video compression systems, the main goal is to adequately represent the video “information” with as little data capacity as possible. Data capacity is defined in bits, either as a constant value or as bits/time (data rate) unit. In both cases, the main goal is to use the least number of bits relative to the information inherent in the video. To arrive at the lower number of bit, the raw video data is compressed to reduce the number of bits need to be transmitted.

Many video compression standards have been developed over the last several years. Many of those methods are standardized through ISO (the International Standards organization) or ITU (the International Telecommunications Union). A number of other proprietary methods have also been developed. The main standardization methods are:

ITU: H.261, H.262, H.263, H.264

ISO: MPEG1, MPEG2, MPEG4/AVC

According to these standards, the first step in the coding process is to divide the picture into square blocks of pixels, for instance 16×16 or 8×8 pixels. This is done for luminance information as well as for chrominance information.

The following prediction process reduces the amount of bits required for each picture in a video sequence to be transferred. It takes advantage of the similarity of parts of the video sequence with other parts of the video sequence, and produces a prediction for the pixels in the block, where the prediction is for a next picture in the video sequence based on an analysis of one or more past pictures in the video sequence. This prediction may be based on pixels in an already coded/decoded picture (e.g., inter prediction) or on already coded/decoded pixels in the same picture (e.g., intra prediction). The prediction is mainly based on vectors representing movements of features displayed in the video sequence.

Since the prediction part is known to both encoder and decoder, only the difference between the predicted and the actual data has to be transferred. This difference typically requires much less data capacity for its representation. The difference between the pixels to be coded and the predicted pixels is often referred to as a “residual”.

The residual represented as a block of data (e.g., 4×4 pixels) still contains internal correlation. A well-known method of taking advantage of internal correlation is to perform a two dimensional block transform. In H.263, an 8×8 Discrete Cosine Transform (DCT) is used, whereas H.264 uses a 4×4 integer type transform. This transforms 4×4 pixels into 4×4 transform coefficients, which can usually be represented by fewer bits than the pixel representation. The transform of a 4×4 array of pixels with internal correlation usually results in a 4×4 block of transform coefficients with much fewer non-zero values than the original 4×4 pixel block. In turn, this increases the amount of information contained in each transmitted bit, and therefore help realize an improved data capacity.

Direct representation of the transform coefficients is still too costly for many applications, and so a quantization process is carried out for a further reduction of the data representation. Moreover, the transform coefficients undergo a quantization process. A simple version of the quantization process divides parameter values by a number—resulting in a smaller number that may be represented by fewer bits. This is the major tool for controlling the bit production and reconstructed picture quality. It should be mentioned that this quantization process has as a result that the reconstructed video sequence is somewhat different from the uncompressed sequence. This phenomenon is referred to as “lossy coding”.

Finally, a so-called “scanning” of the two dimensional transform coefficient data into a one dimensional set of data is often performed, and the one dimensional set is further transformed according to an entropy coding scheme. Entropy coding implies lossless representation of the quantized transform coefficients.

The above steps are listed in a natural order for the encoder. The decoder will to some extent perform the operations in the opposite order and do “inverse” operations as inverse transform instead of transform and de-quantization instead of quantization.

The above operations are depicted in FIG. 1. A source of pixel data 1, may be, for example, an endpoint in a video conference system where the pixel data has already been broken into blocks. The source of pixel data 1, is a memory or memory buffer, having the pixel values recorded therein. The pixel values are then processed in a transform processor 3, which, as discussed above, removes internal correlation between blocks, thus increasing the amount of information per bit. The output of the transform processor 3 is transformation coefficients, which are saved in memory 5, often a buffer, and then processed in a quantizer 7, as discussed above. The transform coefficients are conventionally depicted with the low frequency coefficient (or DC coefficient) positioned in the upper left corner (FIG. 2). Then the horizontal and vertical spatial frequency increase to the right and down. Whether the coefficients are physically stored in memory in this arrangement, or logically, it is not important as long as the order of coefficients is known according to frequency so the scanning operation may be performed in order of frequency.

In FIG. 1 a scanning processor 9 (which can be implemented as a software process) is used that scans from low to high spatial frequency a coefficient, which is normally referred to as zig-zag scanning. In the entropy coding, the coefficients may be scanned in the direction indicated by the arrow, which is referred to as forward scanning, but in other cases the entropy coding may be more efficient if “inverse scanning” (high to low frequency) is used.

After quantization in the quantizer 7 and scanning operator 9, the transform coefficients are represented as signed integer numbers. These numbers are to be conveyed to the decoder without modifications. This is referred to as lossless representation or coding.

At the same time the model for representing the transform coefficients should result in the use of as few bits as possible. Thus, entropy coding is used for performing an optimal representation based on the expected frequency of occurrence of events. This is based on statistics derived from normal image content.

The statistics are used to populate Variable Length Code (VLC) tables to be used for coding. The basic idea is to allocate short code words to frequent events—all done in accordance with the statistics.

Using a variable length code table will result in low bit usage as long as the data to be coded fit reasonably well with the underlying statistics. In the opposite case, when very untypical data is to be coded, the use of bits may become too high. In a situation where the data to be coded fails to fit with the “normal” statistics, occurrences that are represented by a large number of bits will become more frequent. This may occur during rapid and lasting light changes in the environment where the video image is captured. This will harm the quality of the encoded/decoded image as the coding process automatically will adjust the quantization intervals to comply with the frequent occurrence of long code words. Accordingly, as recognized by the present inventor, an inherent problem thereof is increased bit capacity.

### SUMMARY OF THE INVENTION

It is an object of the present invention to provide an improved entropy coding method compared to the state of the art, balancing low complexity with high performance.

In particular, the present invention provides a computer implemented method, apparatus, and computer program product for coding/decoding quantized low frequency and high frequency transform coefficients representing a block of residual pixel values derived from a corresponding block of current pixel values and a block of prediction values by an entropy coding/decoding procedure representing low frequency transform coefficients and high frequency coefficients according to a first VLC adjusted to expected occurrence of coefficient values including the steps of determining whether the block of prediction values exists or can be derived according to one or more predefined rules, and if not then inserting a fixed value in the block of prediction values and using a second VLC specially adjusted to expected occurrence of coefficient values when the block of prediction values are fixed in representing said low frequency coefficients.

### BRIEF DESCRIPTION OF THE DRAWINGS

In order to make the invention more readily understandable; the discussion that follows will refer to the accompanying drawings in which:

FIG. 1 shows a block diagram illustrating the main steps of a coding process according to background art,

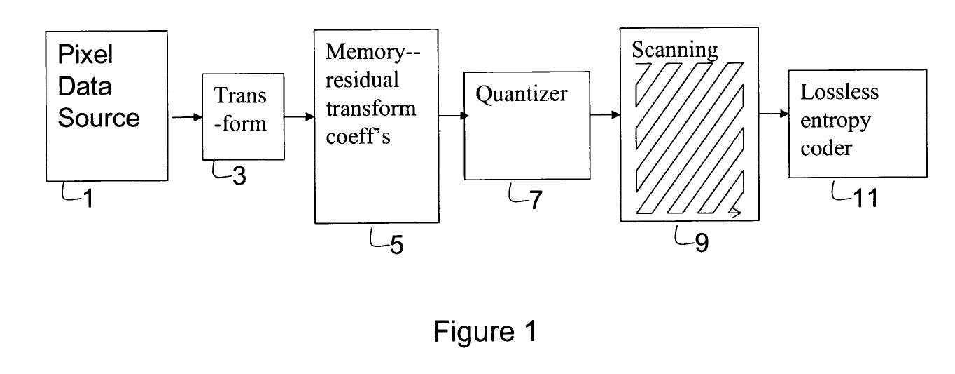

FIG. 2 shows a block in a left hand upper corner of an image where no pixels for intra prediction is available,

FIG. 3 is a table of VLC being used in a PRED mode according to an example embodiment of the present invention, and

FIG. 4 is a table of VLC being used in a NOPRED mode according to an example embodiment of the present invention.

FIG. 5 is a flowchart of a process performed according to an example method of an embodiment of the present invention.

FIG. 6 is a computer system upon which an embodiment of the invention can be implemented.

### DETAILED DESCRIPTION OF THE PREFERRED EMBODIMENTS

The present invention provides a method, apparatus and computer program product for entropy coding of quantized transform coefficients when for some reason no pixels are available for prediction and the VLC codes which are based on statistics for available prediction data, is inexpediently long. The following description is based on the encoder side, but the present invention applies as well to the decoder side, which performs an inverse process.

As recognized by the present inventor, a situation where no pixels are available for prediction may occur for several reasons. There may be no relevant previous pixel data (inter or intra) available for prediction. This could be a result of communication errors, starting of a video sequence, computer disruption, etc.

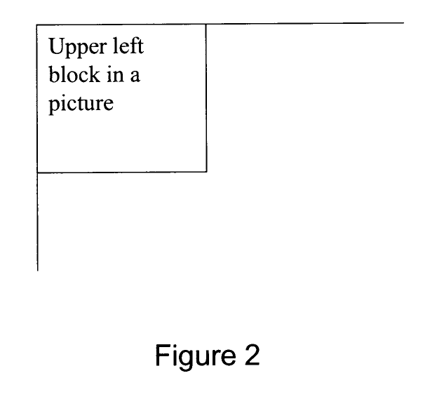

On the other hand, even if inter pixel data is available, there could still be lack of pixel data available for prediction, if for some reason only intra prediction is considered, and there are no pixels above or to the left of the block. This situation is depicted in the example with the upper left block of the picture in FIG. 2.

The same situation would occur if it is desirable not to use pixels external to the block for prediction (e.g., error resilience purposes).

In these cases where there is no prediction data available, conventionally, equipment is made to set the pixel prediction to the mid value of the maximum value. In the case of 8 bit (0-255) pixel representation the pixel prediction for the whole block is set to 128. However, as recognized by the present inventor, this will result in higher residual values than usual. Consequently, the quantized low frequency transformed coefficients, and especially the DC coefficient will also be higher than usually expected. The result may be that the entropy coding model produces more bits than necessary.

According to one embodiment of the present invention, the encoder continuously monitors whether there is a situation of “no prediction” or not. One of two monitored situations occurs when reasonable prediction is possible or the entropy coding can be done reasonably well with the normal entropy coding procedure. This situation is labelled PRED.

The other situation occurs when no reasonably good prediction can be made, and this leads to coding of events that require unreasonably many bits. This situation is labelled NOPRED.

Some examples of NOPRED situations seen from the decoder are disclosed in the following.

The decoder will first typically receive information of a prediction procedure to be used for a block. For example, this may be one of the following:

1) Take the average of the reconstructed pixels just above and just to the left and use this as the prediction.

2) Use the reconstructed pixels just above to predict all the pixels in the block.

3) Use the reconstructed pixels just to the left to predict all the pixels in the block.

4) In situations when transmission errors are expected, the indications can be that no decoded pixels shall be used for prediction—available or not.

The reconstructed pixels just above and just to the left may not be available for prediction for different reasons:

a) The pixels may be outside the picture and therefore not available.

b) The picture may be divided in slices for coding. There may be a rule that pixels outside the slice may not be used for prediction. Hence, if the block to be predicted is on a slice boundary, the pixels may not be available for prediction.

c) Pixels just to the left may not be available because the block to the left is being processed in parallel with the present block and the reconstructed pixels from the block to the left are therefore not ready to be used for prediction.

As can be seen, different combinations of 1-4 and a)-b) may lead to situations when coding of a block of pixels has to be done without reference to any decoded pixels.

According to the first embodiment of the present invention, when NOPRED is detected certain special-purpose steps are carried out.

First of all, in a NOPRED situation, the prediction is set to a fixed value. With 8 bit representation this may typically be 128, as indicated above.

Despite missing “real” prediction data, the encoder is set to a prediction/coding mode so that the encoder/decoder will assume that prediction data still is available.

Then, the encoder/decoder is switched to a different entropy coding strategy where one or a few (such as 16) of the low frequency coefficients are coded separately with VLC tables designed for this situation. The remaining coefficients are still coded with the normal entropy coding procedure, but with the DC coefficients set to zero. The DC coefficient (or a few others, such as 16) is/are consequently defined from the special DC coding process (discussed below) and all the other coefficients are defined by the normal coding process.

When a PRED situation is detected as being present, however, all the coefficients are coded according to the normal procedure.

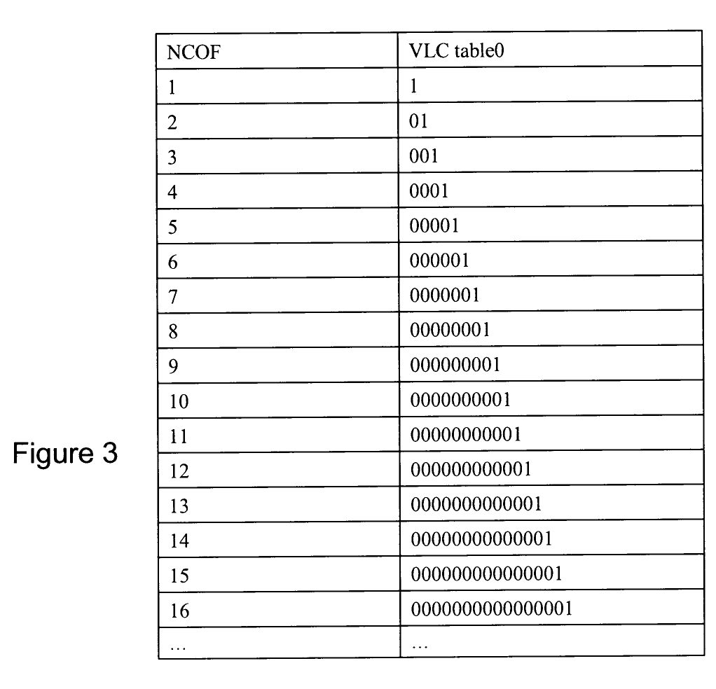

In the PRED situation, the prediction is assumed to be reasonably good and hence the residual to be coded is small. The quantized values to be coded will be integer numbers and many small numbers are to be coded. In this situation a code table with some short code words will be preferable. On the other hand, large numbers may also occasionally occur and the VLC table must have the possibility to also code these numbers. These situations will then require many bits, but as they are rare it still does not cost too much in bits. One possible VLC to be used in such a situation is shown in FIG. 3, with the coefficients in the left column, and the corresponding codes in the right column.

This may, on average, be the best solution, and is the typical characteristics of a commonly used VLC code in normal situations, and hence in PRED situations. Usually very small numbers are to be coded. A large number like 40, on the other hand would need 40 bits to be coded.

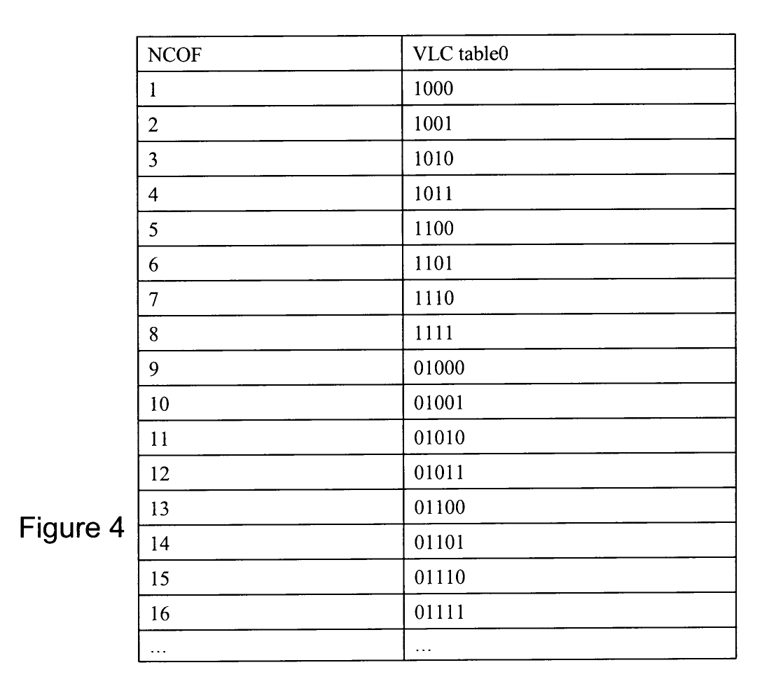

Turning now to the NOPRED situation, as earlier mentioned, mainly the coding of a DC coefficient is considered. The DC component value would ideally represent no movement in a pixel between frames. Since there is no good prediction available, the average value of 128 is used for pixel prediction. The residual to be coded for the DC coefficient in this situation is expected to have a much larger spread than in the PRED situation because in most cases there would be a change in pixel from the predicted pixel value relative to the actual pixel value between frames. This means that the numbers to be coded are typically larger than in the PRED situation, and thus no numbers can be expected to occur very frequently because the mid-value of the pixel range will not be an accurate prediction of the pixel value in many cases. Thus, short code words for particular events are not required (and will not be useful) for bit efficiency. This is because short code words are used to encode values that have a high occurrence rate, and if the mid-point of the pixel-value dynamic range (e.g., 128 in the case of an 8-bit pixel value) is not really a prediction at all, the difference between the mid-point and the actual value is not expected to usually be small. Consequently, it is a poor tradeoff to use short code words for a few values, and longer code words for many other values, if it is expected that short code words will rarely be used. Instead, it would be possible to transmit fewer bits if the VLC uses code words with more uniformly sized code words for a greater number of values. In this situation a more suitable VLC is shown in FIG. 4.

In such a VLC, the shortest code word is 4 bits, for example. On the other hand the number 40 (not shown) only needs 8 bits. Likewise, the number 16 needs only 5 bits, while in the VLC of table 3, the number 16 requires 16 bits. The table of FIG. 4 may consequently use overall fewer bits to code a set of numbers with larger spread. This is seen by comparing the average number of bits used to represent the 16 entries in Tables 3 and 4. The mean code length in the table of FIG. 3 is 8.5 bits, while the mean code length in the table of FIG. 4 is 4.5 bits. If there is no reasonable expectation to believe that the majority of numbers will be concentrated to just a few values, but rather have a more uniform distribution, then using the table in FIG. 4 will result in fewer bits to be transmitted as compared using the table in FIG. 3.

The present invention is useful in situations where it frequently happen that no pixels are available for prediction in a block of pixels to be encoded. This may happen when the coding is done to minimize the influence of transmission bit errors. In such situations the method results in less bit usage. At the same time the implementation cost of the method is minimal.

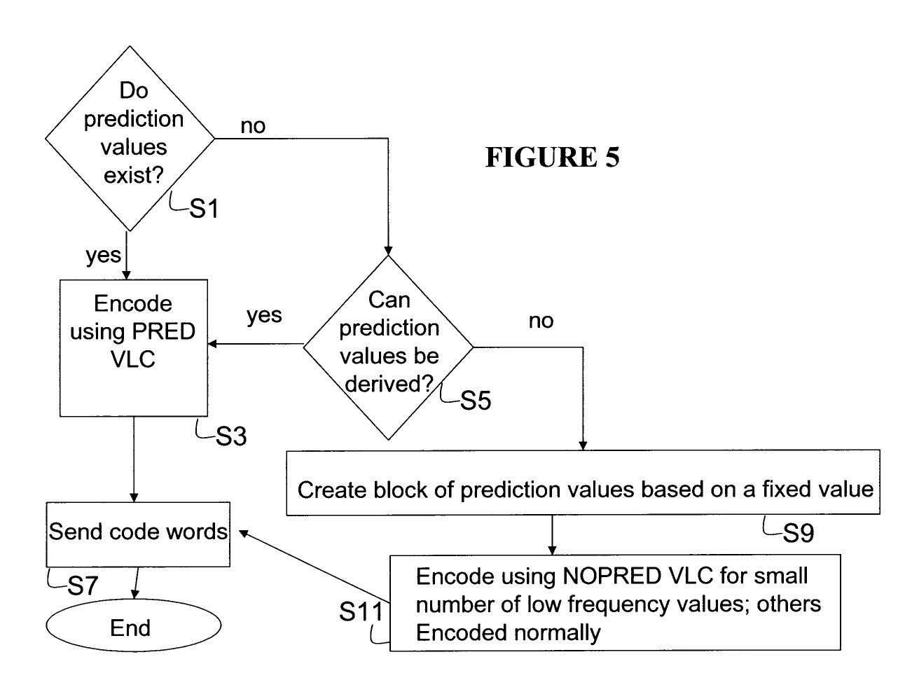

FIG. 5 is a flowchart illustrating a method to be employed according to an embodiment of the present invention. The process starts in step S1, where an inquiry is made regarding whether prediction values exist and are detected. If the response to the inquiry in step S1 is negative, the process proceeds to step SS5, where another inquiry is made regarding whether the prediction values can be derived. When the response to the inquiry in step S1 is affirmative, or the response to the inquiry in step S5 is affirmative, the process proceeds to step S3, where encoding is performed using a PRED VLC.

However, if the response to the inquiry in step S5 is negative, the process proceeds to step S9, where the prediction values are set to a fixed value, such as the middle of the numbers represented by a fixed sized data word (e.g., the number 128 for an 8 bit value). Then encoding is performed for the DC and other low frequency values (e.g., the lowest 16) using a NOPRED VLC, while the other values are encoded normally. After steps S11 and S3, the process proceeds to step S7, where the code words are output from the encoder.

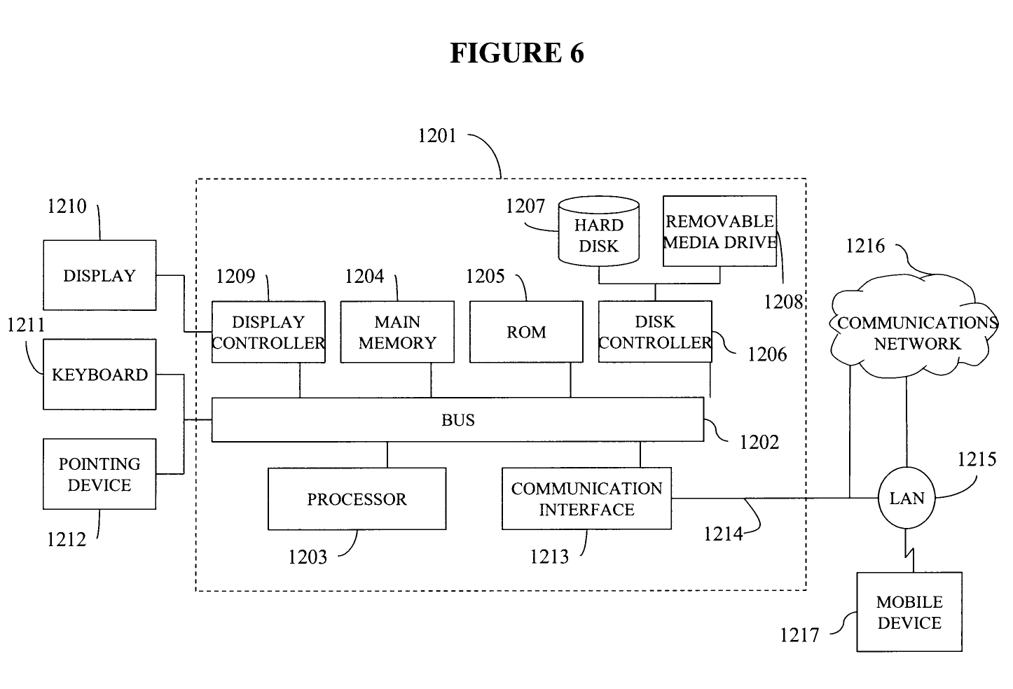

While the present discussion of the process flow in FIG. 6 has been made in the context of an encoder, it follows that an inverse process can be employed for a decoder so as to arrive at the original pixel values (except for any loss in the encoding/decoding process).

FIG. 6 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

1. A computer implemented method for entropy encoding video data, comprising the steps of:
receiving in a processor residual pixel values corresponding to image pixels in said video data;
performing in said processor a two-dimensional transform on said residual pixel values to obtain a block of transform coefficients;
quantizing the transform coefficients;
scanning the transform coefficients after said quantizing step to obtain a one-dimensional set of quantized transform coefficients;
determining whether a block of prediction values exists or a block of prediction values can be derived for said image pixels, wherein
when a positive determination is made in the determining step, encoding the one-dimensional set of quantized transform coefficients using a first variable length coding table adjusted to an expected occurrence of coefficient values, and
when a negative determination is made in the determining step,
creating a block of prediction values based on a fixed value,
encoding at least a DC value and low frequency values of the one-dimensional set of quantized transform coefficients using a second variable length coding table, said second variable length coding table having longer code words for the DC and low frequency values than in said first variable length coding table; and
outputting encoded quantized transform coefficients to an external device for subsequent decoding and presentation on a visual display.

2. The method of claim 1, wherein the step of encoding at least the DC value and low frequency values further includes
representing the DC value and low frequency values with codes from said second variable length code table, and representing remaining quantized transform coefficients that include high frequency values with codes from said first variable length code table.

3. A method according to claim 1, wherein said fixed value is a mid value of a largest coefficient value for a number of bits allocated to represent coefficient values.

4. A method according to claim 1, wherein said determining step includes determining if the block of prediction values can be derived by determining that at least one of a group of four conditions exists
(1) the block of prediction values can be calculated by reconstructed pixels spatially just above the block,
(2) the block of prediction values can be calculated by reconstructed pixels spatially just to the left of the block,
(3) the block of prediction values can be calculated by averaging reconstructed pixels spatially just above and just to the left of the block, and
(4) no decoded pixels are used when an indicia of a transmission is detected or expected.

5. A computer readable medium having computer readable instructions that when executed by a processor perform steps comprising:
receiving in the processor residual pixel values corresponding to image pixels in said video data;
performing in said processor a two-dimensional transform on said residual pixel values to obtain a block of transform coefficients;
quantizing the transform coefficients and storing quantized transform coefficients in a computer readable memory;
scanning the block of transform coefficients in the computer readable memory after said quantizing step to obtain a one-dimensional set of quantized transform coefficients;
determining whether a block of prediction values exists or a block of prediction values can be derived for said image pixels, wherein
when a positive determination is made in the determining step, encoding the one-dimensional set of quantized transform coefficients using a first variable length coding table adjusted to an expected occurrence of coefficient values, and
when a negative determination is made in the determining step,
creating a block of prediction values based on a fixed value,
encoding at least a DC value and low frequency values of the one-dimensional set of quantized transform coefficients using a second variable length coding table, said second variable length coding table having longer code words for the DC value and low frequency values than in said first variable length coding table; and
outputting encoded quantized transform coefficients to an external device for subsequent decoding and presentation on a visual display.

6. The computer program product of claim 5, wherein the step of encoding at least DC and low frequency values further includes the step of:
representing the DC value and low frequency values with codes from said second variable length code table, and remaining quantized transform coefficients that include high frequency values with codes from said first variable length code table.

7. The computer program product of claim 5, wherein said fixed value is a mid value of a largest coefficient value for a number of bits allocated to represent coefficient values.

8. The computer program product of claim 5, wherein said determining step includes determining if the block of prediction values can be derived by determining that at least one of a group of four conditions exists
(1) the block of prediction values can be calculated by reconstructed pixels spatially just above the block,
(2) the block of prediction values can be calculated by reconstructed pixels spatially just to the left of the block,
(3) the block of prediction values can be calculated by averaging reconstructed pixels spatially just above and just to the left of the block, and
(4) no decoded pixels are used when an indicia of a transmission is detected or expected.

9. An encoder configured to perform entropy encoding on video data, comprising:
a processor configured to receive residual pixel values corresponding to image pixels in said video data, and perform a two-dimensional transform on said residual pixel values to obtain a block of transform coefficients, and quantize the transform coefficients;
a computer readable memory configured to store said block of transform coefficients after being quantized by said processor, wherein
said processor is configured to
scan the transform coefficients in said memory to obtain a one-dimensional set of quantized transform coefficients,
determine in a determining step whether a block of prediction values exists or a block of prediction values can be derived for said image pixels, wherein
when a positive determination is made in the determining step, the processor encodes the one-dimensional set of quantized transform coefficients using a first variable length coding table adjusted to an expected occurrence of coefficient values, and
when a negative determination is made in the determining step, the processor
creates a block of prediction values based on a fixed value,
encodes at least a DC value and low frequency values of the one-dimensional set of quantized transform coefficients using a second variable length coding table, said second variable length coding table having longer code words for the DC value and low frequency values than in said first variable length coding table, and
outputs encoded quantized transform coefficients to an external device for subsequent decoding and presentation on a visual display.

10. The encoder of claim 9, wherein the processor represents the DC value and low frequency values with codes from said second variable length code table, and remaining quantized transform coefficients that include high frequency values with codes from said first variable length code table.

11. The encoder of claim 9, wherein said fixed value is a mid value of a largest coefficient value for a number of bits allocated to represent coefficient values.

12. The encoder of claim 9, wherein said processor is configured to determine if the block of prediction values can be derived by determining that at least one of a group of four conditions exists
(1) the block of prediction values can be calculated by reconstructed pixels spatially just above the block,
(2) the block of prediction values can be calculated by reconstructed pixels spatially just to the left of the block,
(3) the block of prediction values can be calculated by averaging reconstructed pixels spatially just above and just to the left of the block, and
(4) no decoded pixels are used when an indicia of a transmission is detected or expected.

13. A videoconferencing component comprising:
an encoder configured to perform entropy encoding on video data, comprising:
a processor configured to receive residual pixel values corresponding to image pixels in said video data, and perform a two-dimensional transform on said residual pixel values to obtain a block of transform coefficients, and quantize the transform coefficients;
a computer readable memory configured to store said block of transform coefficients after being quantized by said processor, wherein
said processor is configured to
scan the transform coefficients in said memory to obtain a one-dimensional set of quantized transform coefficients,
determine in a determining step whether a block of prediction values exists or a block of prediction values can be derived for said image pixels, wherein
when a positive determination is made in the determining step, the processor encodes the one-dimensional set of quantized transform coefficients using a first variable length coding table adjusted to an expected occurrence of coefficient values, and
when a negative determination is made in the determining step, the processor
creates a block of prediction values based on a fixed value,
encodes at least a DC value and low frequency values of the one-dimensional set of quantized transform coefficients using a second variable length coding table, said second variable length coding table having longer code words for the DC value and low frequency values than in said first variable length coding table, and
outputs encoded quantized transform coefficients to an external device for subsequent decoding and presentation on a visual display; and
said video conferencing component further including a decoder configured to decode said encoded quantized transform coefficients and perform an inverse process on said encoded quantized transform coefficients so as to obtain said image pixels in said video data.
